(19) United States
(12) Patent Application Publication
(10) Pub. No.: US 2023/0340674 A1
(43) Pub. Date: Oct. 26, 2023

(54) Oval, rounded or circular electrolytic cell device completely encased in a seal for enhancing combustion in an internal combustion engine.

(71) Applicant: Fernando Suarez Pariente, Puebla (MX)

(72) Inventor: Fernando Suarez Pariente, Puebla (MX)

(21) Appl. No.: 17/724,521

(22) Filed: Apr. 20, 2022

(51) Int. Cl. C25B 1/04; C25B 9/70; C25B 9/17; C25B 9/65; C25B 11/036; C25B 11/046; C25B 15/08

(52) U.S. Cl. CPC C25B 1/04; C25B 9/70; C25B 9/17; C25B 9/65; C25B 11/036; C25B 11/046; C25B 15/081; F02M 21/0206

(57) ABSTRACT

Oval, rounded or circular electrolytic cell designed for use in internal combustion engines that produces hydrogen/oxygen gases from water through an electrolysis process made up of at least seven oval metal plates and closed within two closing seal blocks, upper closing block (4) and lower closing block (6), made of non-conductive material such as plastic and rubber-type materials; where the five central plates are neutral electrolytic plates (1) and the plates at the two ends are the anode electrolytic plate (2) and the cathode electrolytic plate (3) and they are connected to current by means of two electrode cables (8) protected by a cable insulator (9) and at the closures they have lower electrolyte inlet slots (7) and other upper gas outlet slots (5), which, given the oval design of the cell, allow the gases generated during the electrolysis process to easily escape through the top openings and the electrolyte to easily and continuously replenish in each cell through the lower openings.

An oval, rounded or circular electrolytic cell device completely encased in a seal for enhancing combustion in an internal combustion engine

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

The field of the invention is that of the internal-combustion piston engines and combustion engines in general.

### Description of Related Art

There are currently two main types of electrolytic cell designs:
a. The so-called “wet” cells, which are those in which the electrolytic cell is totally submerged in the water/electrolyte.

The cells contain the electrodes with electrical current applied to them. The electrodes are separated by plastic or rubber spacers.

The problem they present is that they are exposed to water/electrolyte that interrupts the flow of current and also serious current leakage occurs, drawing much higher amperage from the electrical system than necessary, which makes the cell very inefficient.
b. The so-called “dry” cells, which are not submerged in the water/electrolyte, so they do not have the same current leaks as “wet” cells, since they use gaskets as spacers to contain the electrolyte within the cell. They employ multiple cells in series by having several plates of cells stacked between the electrodes, commonly known as “neutral” plates.

However, they have other problems. Among them we can highlight:
b.1. HHO gas can be trapped/delayed in the cell, because it has to travel through all the cell plates through a small hole in each “neutral” plate to the main (and only) outlet of gas.
b.2. The water does not completely fill the entire space of the cell, because the gases generated push the water level down, so that there is less water/electrolyte available for electrolysis, so a higher current is needed to obtain the same amount of HHO gas.

The consequence is that both types of cells need much more current to make enough gas than they would otherwise. This means a situation of high amperage and lower gas output, which makes them inefficient.

To solve all these efficiency problems and obtain a surprisingly high efficiency result, the invention proposes a new cell design that overcomes the deficiencies of the current art.

This new design uses the advantages of the “wet” cell and “dry” cell models. It can be used inside a water tank (with electrolyte) without current leakage making it much more efficient electrically and chemically, which is fundamental in the electrolysis that is already an energy-intensive process; especially in mobile applications (such as IC engines).

One part of the invention is a unique seal that prevents the cell from leaking current and totally isolates the metal plates and electrodes from the water/electrolyte and keeps the electrolyte isolated within each cell.

The other part of the invention is related to the shape of the metal plate of the cell, which is a simple oval shape (it can be rounded or circular); where the current state of the art exclusively uses square cell plates, tubes and wire mesh. Oval, rounded or circular plates provide special benefits in the cells. Because it works in conjunction with the other part of the invention (the seals); together they increase the efficacy of the electrolytic cell significantly.

On the part of the inventor, he is not aware of any relevant prior art that anticipates the design that is carried out in this application.

### BRIEF SUMMARY OF THE INVENTION

The oval electrolytic cell designed for use in internal combustion engines that produces hydrogen/oxygen gases from water through an electrolysis process, to improve combustion efficiency and reduce harmful emissions has been designed to be used in internal combustion engines and produces hydrogen/oxygen gases from water through an electrolysis process, then used to improve combustion efficiency and reduce harmful emissions.

It is a unique electrolytic cell to work on demand, without the need for storage tanks, efficiently and safely.

It is also important to note that the device is designed to work submerged in water/electrolyte.

The hydrogen generation system works on the principle of electrolysis, in which water molecules are split into hydrogen gas and oxygen when electric current is applied to electrodes immersed in an electrolyte solution.

The hydrogen/oxygen gas (a.k.a. HHO) produced can be transferred to the combustion engine, usually through the air intake, where it mixes effectively with the fuel.

This helps fuel burn more efficiently, increasing mileage and reducing harmful emissions, which translate into improved performance and greatly reduced pollution.

The cell produces only the necessary amount of hydrogen that is continually used up, so there is no buildup of excess or compressed hydrogen gas in the system.

The most innovative features of the invention are the special design of the joints of a sealing system in conjunction with the oval-shaped cell plates (which may be rounded or circular.

In the cell pack several plates, i.e. the electrodes and the so-called neutral plates, are placed parallel to each other with a certain distance between them.

When electricity is applied to the two end plates, the ones that function as electrodes, current flows between the “neutral” plates as well, acting as individual cells connected in series.

A unique sealing device completely encloses them individually around the edges, isolating them from one another, preventing current leakage into the electrolyte.

Small openings at the top and bottom of the sealing devices ensure that the electrolyte and gases can flow independently into each cell.

### BRIEF DESCRIPTION OF THE SEVERAL VIEWS OF THE DRAWING

To complement the description that is being made and in order to help a better understanding of the characteristics of the invention, a set of drawings is attached as an integral part of said description, where for illustrative and non-limiting purposes, the following has been represented: following:

FIG. 1. Shows a sectional view of the plates

FIG. 2. Shows a side sectional view of the closing blocks (seals)

FIG. 3 Shows an isometric view of the upper closing block

FIG. 4 Shows an isometric view of the lower closing block

FIG. 5 Shows an isometric view of the oval electrolytic cell

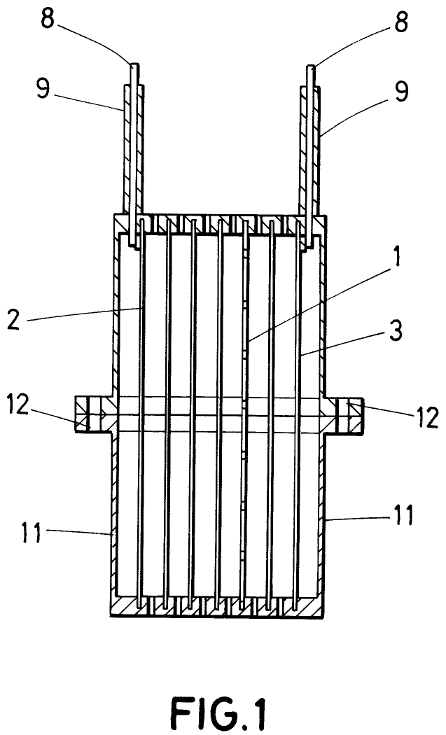

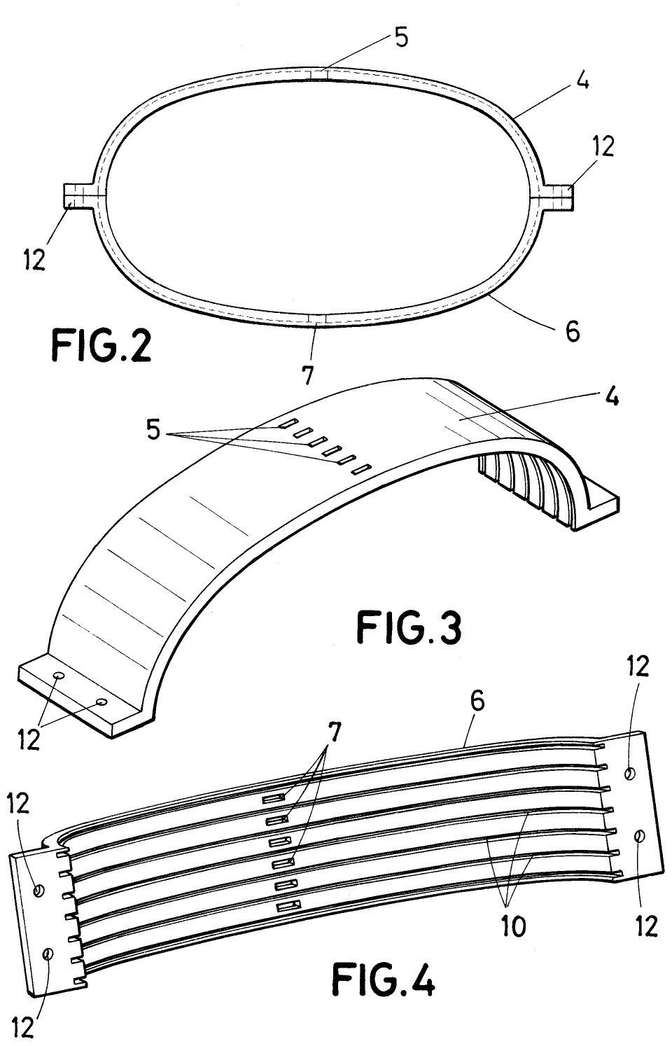

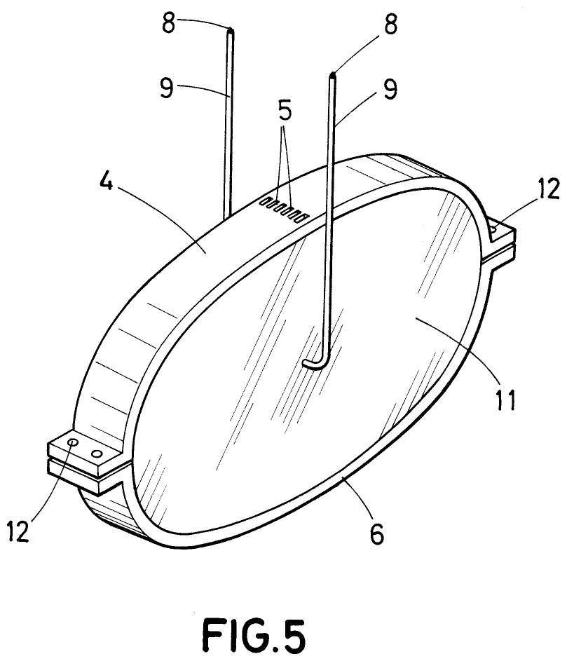

### AND IN THESE FIGURES THE SAME ELEMENTS ARE IDENTIFIED WITH IDENTICAL NUMBERING

(1). neutral metal plates,
(2). metal anode plate,
(3). metal cathode plate,
(4). upper closing block,
(5). upper gas outlet slots,
(6). lower closing block,
(7). Lower electrolyte inlet slots,
   (8). electrode cable,
   (9). insulation of the electrode cable,
(10). plate coupling channels,
(11). closing side walls,
(12). mechanical seal of the upper (4) and lower (6) blocks

### DETAILED DESCRIPTION OF THE INVENTION

### Description of the Preferred Embodiment

The device that the invention proposes incorporates novel characteristics in relation to other elements used within the sector and that solves problems that until now were complicated to solve, with great simplicity and efficiency.

The proposed invention refers to an oval electrolytic cell designed for use in internal combustion engines that produces hydrogen/oxygen gases from water through an electrolysis process, to improve combustion efficiency and reduce harmful emissions.

In a more detailed way, the oval electrolytic cell is made up of at least seven metal plates, of which the central five are neutral electrolytic plates (1) and those at the two ends are electrically connected electrolytic plates, one will be the anode electrolytic plate (2) and the opposite the cathode electrolytic plate (3).

Both the anode electrolytic plate (2) and the cathode electrolytic plate (3) are connected to current by means of respective electrode cables (8) protected by a cable insulator (9).

The two end metal plates (2) and (3) are the positive and negative electrodes with 5 or more neutral metal plates (1) evenly spaced between them.

They are called neutral metal plates (1) because there is no direct electricity on them. Only the end plates (2) anode and (3) cathode are connected to electricity (DC).

The device works because electricity is carried by the negative and positive ions in the electrolyte between the plates from the anode to the cathode and vice versa through all the neutral metal plates. One side of each neutral metal plate functions as the positive electrode and the other as the negative electrode.

Therefore we find a set of metal plates that works as individual cells connected in series, where the voltage drops uniformly between the individual cells and this means that in a system of 7 metal plates there are 6 cells in series in a 12V DC system.

These neutral metal plates (1), anode (2) and cathode (3) are closed within two closure blocks (seals), upper closure block (4) and lower closure block (6), made of non-conductive material as can be seen, be plastic or rubber type material.

Both the upper closing block (4) and the lower closing block (6) are identical and homothetic to each other, with a series of openings in the form of slots at their upper and lower ends, the upper ones being the gas outlet slots (5), and the lower ones the electrolyte inlet slots (7).

Similarly, both the upper closing block (4) and the lower closing block (6) have on their inner faces respective coupling channels for the plates (10), so that the plates are separated by the appropriate distance and that the closure of the cell is perfect, that it prevents the cell from leaking current and totally isolates the metal plates and the electrodes from the water/electrolyte and keeps the electrolyte isolated inside each cell.

With this special design, when electricity is applied to the two electrode plates (2) and (3) located at the ends, the current also flows between the “neutral” plates, acting as individual cells connected in series.

The total sealing of the cell is constituted by the total adjustment between the closing blocks (4) and (6), which completely closes all the plates individually, by means of the closing side walls (11) and the closing (12) between the two, made up of through bolts with nuts, thus achieving the isolation of all the plates from others, which prevents leakage of current into the electrolyte.

The lower electrolyte inlet slots (7) ensure that the electrolyte can flow perfectly and independently in each cell and also the water/electrolyte can be replenished easily and continuously. Because the water/electrolyte is free to flow, the total surface areas of the plates are utilized at all times.

The cell plate shapes are oval (they can be rounded or circular) which doesn't obstruct the gas flow; due to their curvy shapes the gases are guided smoothly and speedily to the top openings within the seal and will not be trapped in the individual cells thus they can easily exit from the cells. It guides the gases around the curves for a speedier escape so the gas bubbles on the surface of the plates don't have time to group together obstructing and neutralizing some of the gas flow.

In another embodiment of the invention the seals are individual seals for each cell plate, with the exact same configuration as the previously described seals, and openings on top and bottom. Then the plates are stocked tightly all together and the ensemble closed with the end plates.

1. An oval, rounded or circular electrolytic cell device encased in a seal for enhancing combustion in an internal combustion engine comprising:
at least seven oval metal plates
two closing seal blocks made of non-conductive material, plastic, or rubber-type substance.
an upper closing block (4) and
a lower closing block (6).

2. The cell of claim 1 wherein the five central plates are neutral electrolytic plates (1) and the first and last cells are connected electrolytic plates, one will be the anode electrolytic plate (2) and the opposite one the cathode electrolytic plate (3).

1. An oval, rounded or circular electrolytic cell device encased in a seal for enhancing combustion in an internal combustion engine comprising:
at least seven oval metal plates
two closing seal blocks made of non-conductive material, plastic, or rubber-type substance.
an upper closing block (4) and
a lower closing block (6).

2. The cell of claim 1 wherein the five central plates are neutral electrolytic plates (1) and the first and last cells are connected electrolytic plates, one will be the anode electrolytic plate (2) and the opposite one the cathode electrolytic plate (3).

3. The cell of claim 2 wherein both the anode electrolytic plate (2) and the cathode electrolytic plate (3) are connected to current by means of two electrode cables (8) protected by a cable insulator (9).

4. The cell of claim 3 wherein the two end metal plates (2) and (3) are positive and negative electrodes with 5 or more neutral metal plates (1) evenly spaced between them.

5. The cell of claim 1 wherein the central plates are called neutral metal plates (1) because there is no direct electricity in them.

6. The cell of claim 1 wherein both the anode electrolytic plate (2) and the cathode electrolytic plate (3) are connected to electricity (DC).

7. The cell of claim 1 wherein the neutral metal plates (1), the anode plate (2) and the cathode plate (3) are enclosed within an upper closure block (4) and a lower closure block (6), and by closing lateral plates (11) and a mechanical closing (12) constituted by passing screws with tightening nuts.

8. The cell of claim 7 wherein the upper closing block (4) and the lower closing block (6) are identical and homothetic to each other, with a series of openings in the form of slots at their upper end that are the gas outlet slots (5) and at their lower end, that are the electrolyte inlet slots (7).

9. The cell of claim 1 wherein the upper closing block (4) and the lower closing block (6) present on their inner faces respective coupling channels for the plates (10).

10. The cell of claim 1 wherein in an specific case the oval shape of the cell can be modified to a rounded or circular shape.

11. The cell of claim 1 wherein the closing seal blocks (4) and (6) are individual for each cell plate (1), (2) and (3), and then the plates (1), (2) and (3) are stocked tightly all together and the ensemble closed with the closing lateral plates (11).

12. The method to work the cell of claim 1 wherein the operating procedure thereof begins when electricity is transported by the negative and positive ions of the electrolyte between the plates from the anode (2) to the cathode (3) and vice versa through all the neutral metal plates so that a side of each neutral metal plate (1) works as a positive electrode and the other side as a negative electrode.

13. The method of claim 11 wherein the set of metal plates works as individual cells connected in series, where the voltage drops uniformly between the individual cells and wherein in a system of 7 metal plates there are 6 cells in series in a 12V DC system.
